(19) United States
(12) Patent Application Publication
(10) Pub. No.: US 2015/0117299 A1
(43) Pub. Date: Apr. 30, 2015

(54) DISTRIBUTED INFORMATION SOURCE ESTIMATION METHOD BASED ON COOPERATIVE COMMUNICATION

(71) Applicant: Beihang University, Beijing (CN)

(72) Inventors: Jun ZHANG, Beijing (CN); Qiang GAO, Beijing (CN); Yu HAN, Beijing (CN)

(73) Assignee: Beihang University, Beijing (CN)

(21) Appl. No.: 14/064,195

(22) Filed: Oct. 28, 2013

(51) Int. Cl. H04L 25/02; H04W 52/30; H04B 7/155

(52) U.S. Cl. CPC H04L 25/0256; H04B 7/15592; H04W 52/30
USPC 370/315

(57) ABSTRACT

The present invention discloses a distributed information source estimation method based on cooperative communication, which comprises the following steps: the fusion center selects a relay node with the best channel quality from a plurality of sensor nodes, according to the current channel quality between each sensor node and the fusion center; said fusion center carries out transmission power distribution on each sensor node, according to the observation quality of each sensor node towards an information source and the current channel quality between each sensor node and the fusion center; each sensor node judges whether it is a relay node or not; the sensor node directly transmits the observation information obtained by observing the information source to said fusion center; the sensor node transmits the observation information obtained by observing the information source to said fusion center.

### BACKGROUND OF THE INVENTION

1. Field of the Invention

The present invention relates to a wireless network technology, and particularly to a distributed information source estimation method based on cooperative communication.

2. Background of the Invention

Distributed estimation of information source is one of the important application is of the wireless sensor network. The wireless sensor network consists of a plurality of sensor nodes and a fusion center. The plurality of sensor nodes observe a single information source and then send their corresponding observation results to the fusion center, and the fusion center carries out estimation on the information source based on these results.

In the existing distributed estimation system, the plurality of sensor nodes observe the information source independently, and each sensor node directly transmits the obtained observation information to the fusion center through a wireless channel. The fusion center carries out information fusion on the plurality of observation information obtained by observing in the plurality of sensor nodes, thus obtaining the estimation result of the information source. During the process in which the sensor node transmits the observation information to the fusion center, the sensor node transmits the information in a broadcast fashion. Since the transmit signal is subject to influences like multipath fading, noise, and interference, the observation information of some sensor nodes can not be transmitted effectively to the fusion center. It is possible that the observation information, which has been transmitted to the fusion center, is not information with a high observation quality, which leads to a low accuracy for the fusion center to estimate the information source. Therefore, there is a need for a distributed estimation method with high estimation accuracy.

### BRIEF SUMMARY OF THE INVENTION

The present invention provides a distributed estimation method based on cooperative communication, which is capable of effectively transmitting observation information through sensor nodes with a relatively higher observation quality, and thus enables a distributed estimation method with high estimation accuracy.

To this end, the present invention provides a distributed information source estimation method based on cooperative communication, which comprises the following steps:

step 1, the fusion center selects a relay node with the best channel quality from a plurality of sensor nodes, according to the current channel quality between each sensor node and the fusion center;

step 2, said fusion center carries out transmission power distribution on each sensor node, according to the observation quality of each sensor node towards an information source and the current channel quality between each sensor node and the fusion center;

step 3, each sensor node judges whether it is a relay node or not, if so, the method proceeds to step 4, and if not, the method proceeds to step 5;

step 4, the sensor node directly transmits the observation information obtained by observing the information source to said fusion center;

step 5, the sensor node transmits the observation information obtained by observing the information source to said fusion center and the relay node monitors the observation information, then the relay node retransmits the observation information to said fusion center;

step 6, said fusion center fuses all of the received observation information to obtain the estimation value of the information source.

Preferably, in the distributed information source estimation method based on cooperative communication, the method further comprises the following step between said steps 1 and 2:

channel estimation is carried out on transmit channels between each sensor node and the fusion center to obtain the channel quality.

Preferably, in the distributed information source estimation method based on cooperative communication, in said step 2, the transmission power distribution method is performed in the following manner:

said fusion center adopts a numerical solution method for a convex optimization problem to solve an optimization problem which comprises the following conditions: 1) a total transmission power constraint of a system consisting of said fusion center and said plurality of sensor nodes; 2) a transmission power upper constraint for each sensor node; and 3) a transmission power lower constraint for each sensor node, and finally carries out transmission power distribution on all sensor nodes by applying the solving result.

Preferably, in the distributed information source estimation method based on cooperative communication, said step 5 specifically comprises:

in a first time slot for information transmission of the information source, the sensor node transmits the observation information obtained by observing the information source to said fusion center, while the relay node monitors the observation information;

prior to a second time slot for information transmission of the information source, the relay node retransmits the monitored observation information to said fusion center in an amplify-forward manner.

Preferably, in the distributed information source estimation method based on cooperative communication, said step 6 specifically comprises:

said fusion center fuses all of the received observation information with a best linear unbiased estimation method to obtain the estimation value of the information source.

The present invention has the following technical effects.

According to the current channel quality between each sensor node and the fusion center, a relay node is determined by the fusion center. The relay node cooperates with the remaining sensor nodes to transmit the observation signal, so as to improve its signal transmission quality, and further improve the estimation accuracy. The method of the present invention provides an improved mean square error performance and outage probability performance.

### BRIEF DESCRIPTION OF THE DRAWINGS

FIG. 1 is a diagram illustrating a cooperative communication flow in a distributed information source estimation system based on cooperative communication of the present invention;

FIG. 2 is flow chart illustrating an embodiment of the distributed estimation method based on cooperative communication of the present invention;

FIG. 3 is an operation flow chart illustrating transmission power distribution in an embodiment of the present invention;

FIG. 4 is a diagram of simulation result test for comparing the estimation mean square error between the present invention and the prior art; and

FIG. 5 is a diagram of simulation result test for comparing the outage probability between the present invention and the prior art.

### DETAILED DESCRIPTION OF THE INVENTION

The specific embodiments of the present invention will be described hereinafter by referring to the accompanying drawings.

In the present invention, a wireless sensor network system comprises an information source θ, a plurality of sensor nodes 1, 2, 3, . . . , K, and a fusion center FC. According to the channel quality by which said plurality of sensor nodes transmits signals towards the fusion center FC, the fusion center FC selects a sensor node with the best channel quality from the plurality of sensor nodes as a relay node. The selected sensor node plays a relay role for information transmission of the remaining sensor nodes. The fusion center FC carries out channel estimation on the transmit channel of each sensor node to obtain the channel quality. The fusion center FC further detects the observation quality of each sensor node towards the information source to obtain the observation quality. According to the current channel quality and observation quality, the fusion center FC also carries out transmission power distribution on each sensor node. The fusion center FC further fuses all of the received observation information to obtain the estimation value of said information source. Said plurality of sensor nodes are used to observe said information source to obtain the observation information. If a sensor node acts as a relay node, the sensor node helps the remaining sensor nodes to transmit the observation information. Besides, the observation information of the relay node is directly transmitted. If a sensor node is not a relay node, the sensor node not only transmits its own observation information, but also transmits the observation information in an amplify-forward manner through the relay node. In other words, as for a sensor node which is not the relay node, its observation information is transmitted to the fusion center FC in two times.

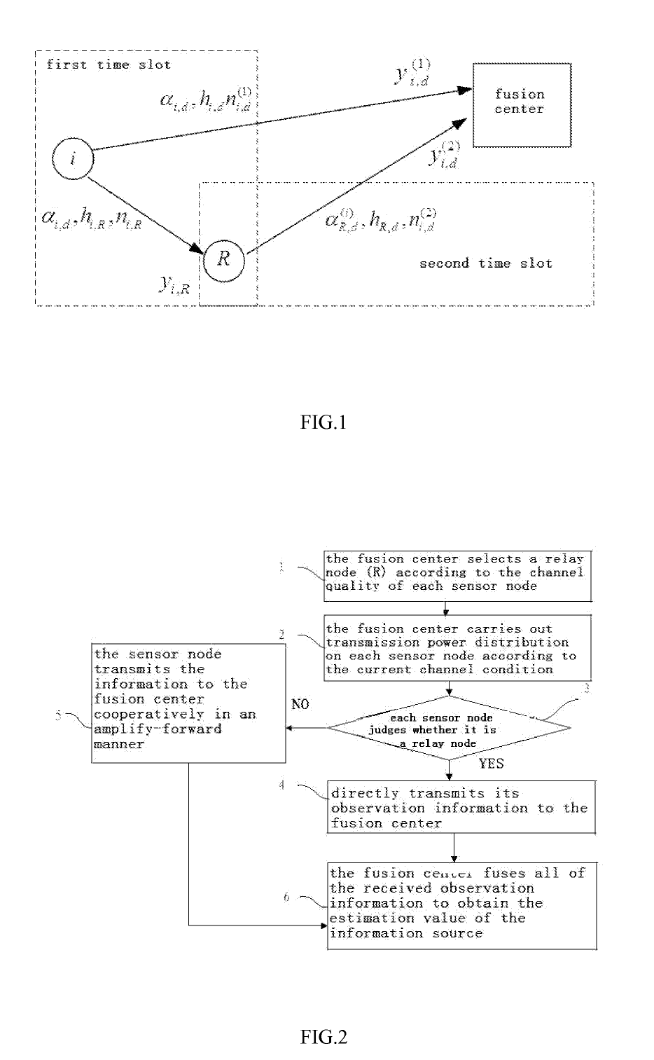

The mode of information transmission in the cooperative communication is shown in FIG. 1. A single transmit consumes two time slots. In the first time slot, the sensor node transmits its observation information to the fusion center, meanwhile the relay node monitors this information and transmits the observation information to the fusion center prior to the second time slot for a second time.

FIG. 2 is flow chart illustrating an embodiment of the distributed estimation method based on cooperative communication of the present invention. Referring to FIG. 1, the method in this embodiment comprises:

step 1, the fusion center selects a relay node with the best channel quality from a plurality of sensor nodes, according to the current channel quality between each sensor node and the fusion center;

step 2, said fusion center carries out transmission power distribution on each sensor node, according to the observation quality of each sensor node towards an information source and the current channel quality between each sensor node and the fusion center;

step 3, each sensor node judges whether it is a relay node or not, if so, the method proceeds to step 4, and if not, the method proceeds to step 5;

step 4, the sensor node directly transmits the observation information obtained by observing the information source to said fusion center;

step 5, the sensor node transmits the observation information obtained by observing the information source to said fusion center and the relay node monitors the observation information, then the relay node retransmits the observation information to said fusion center;

step 6, said fusion center fuses all of the received observation information to obtain the estimation value of the information source.

In this embodiment, first of all, the fusion center determines a node who will act as a relay node according to the channel quality of each sensor node in the network. This node helps other nodes to transmit information in an amplify-forward manner, so as to improve the information transmission quality of the latter, and thus improve estimation accuracy. Specifically, when each sensor node in the network observes the same information source, not only the observation quality differs from each other, but also the condition of the channel through which each node transmits data to the fusion center (i.e., channel estimation value) differs from each other. When the sensor node transmits observation data to the fusion center, it is expected to transmit the observation information of a node with a relatively high observation quality to the fusion center as effectively as possible. In the present invention, the node with the best channel quality acts as the relay node, so that it is ensured that the observation information of the node can be transmitted to the fusion center as effectively and accurately as possible. In order to improve the utilization of observation information in the network, the relay node directly transmits its own observation information to the fusion center, so that a more accurate estimation value of the information source can be obtained.

In the above embodiment, the fusion center can not only obtain the channel quality of the transmit channel of each sensor node by carrying out a real time channel estimation, but also obtain the pre-stored channel quality of the node. When a new channel quality is being obtained, the fusion center further comprises the following step between steps 1 and 2: carrying out channel estimation on transmit channels between each sensor node and the fusion center to obtain the channel quality. Of course, the fusion center may also carry out channel estimation of the node after each round of calculating the estimation value of the information source is completed so as to obtain the channel quality, and take this channel quality as the basis for selecting the relay node. In addition, the channel quality and the observation quality are taken as the basis for the fusion center to carry out transmission power distribution in the next time.

In the method described in the present invention, in the wireless sensor network system it is assumed that:

1) the communication noise among nodes and the communication noise between the node and the fusion center FC are both independent and identically distributed;

2) the communication noise in the network follows a Gaussian distribution with the same statistical properties;

3) the distance between the sensor node and the fusion center is large, while the distance between sensor nodes is small. Therefore, the distances between all nodes and the fusion center can be regarded as approximately the same.

4) the channel from the node to the fusion center follows a Rayleigh model.

The present invention adopts the following simplified processing to obtain the approximate value of the estimation error. Due to the fact that the sensor nodes are densely distributed and the distance between nodes is small, the channel fading is ignored during modeling the channel between nodes. Besides, since the distance between nodes is far smaller than the distance between the node and the fusion center, the error originating from the communication between nodes is very limited. For simplicity, it is supposed that the distance between any two nodes is the diameter of the distribution range of the sensor nodes.

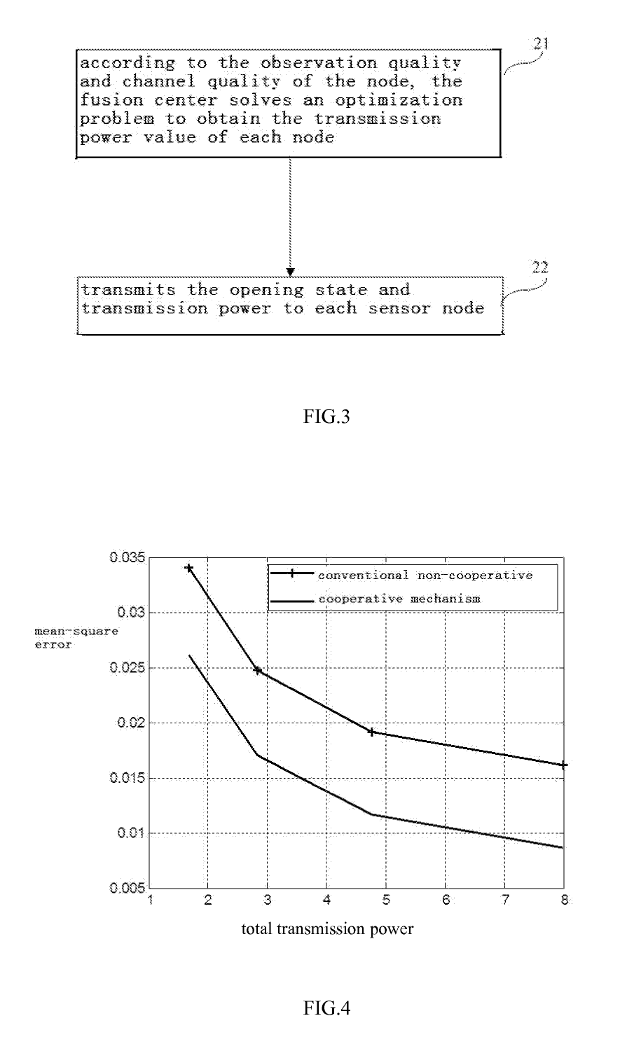

FIG. 3 is an operation flow chart illustrating transmission power distribution in an embodiment of the present invention. As shown in FIG. 3, the method for transmission power distribution is performed in the following manner. According to the channel estimation value and the observation quality of the node, said fusion center solves an optimization problem to obtain the transmission power value of each node, and re-transmits said opening state and transmission power to each sensor node. Specifically, said fusion center adopts a numerical solution method for a convex optimization problem to solve an optimization problem which comprises the following conditions: 1) a total transmission power constraint of a system consisting of said fusion center and said plurality of sensor nodes; 2) a transmission power upper constraint for each sensor node; and 3) a transmission power lower constraint for each sensor node, and finally carries out transmission power distribution on all sensor nodes by applying the solving result.

The power distribution process and the solving principles as mentioned above will be analyzed in detail hereinafter.

Firstly, the system performance is analyzed and the information transmission process is described. As for a non-relay node, the following stands:

y_{i,d}⁽¹⁾=\sqrt{α_{i,d}}h_{i,d}xᵢ+n_{i,d}⁽¹⁾,i≢R

y_{i,R}=\sqrt{α_{i,d}}h_{i,R}xᵢ+n_{i,R}

y_{i,d}⁽²⁾=\sqrt{α_{R,d}⁽ⁱ⁾}h_{R,d}y_{i,R}+n_{i,d}⁽²⁾ (1)

xᵢ represents the value obtained by observing in the i^{th} node, where xᵢ=θ+nᵢ, and θ is an additive Gaussian information source with a variance of σ_{θ}². nᵢ is the observation noise of the i^{th} node, which is an additive Gaussian white noise with a variance of σᵢ². n_{i,d}⁽¹⁾,n_{i,d}⁽²⁾,n_{i,R} refers to the channel noise of the responding channel, all of which are additive Gaussian white noises with a variance of ξ². y_{i,d}⁽¹⁾,y_{i,d}⁽²⁾ indicate the signals received by the fusion center in the first and second time slot respectively (d indicating the target terminal, in this case the fusion center). y_{i,R} indicates the signal sent by the i^{th} node which is monitored in the first time slot by the node R. α_{i,d},α_{R,d}⁽ⁱ⁾ indicate the amplify-forward coefficients of the i^{th} node and the relay node R, and the relationship between these coefficients and the transmission power is described as follows: (i) in case P_{i,d} represents the power used for transmitting observation information by the i^{th} node, P_{i,d}=α_{i,d}(σ_{θ}²+σᵢ²), and (ii) in case P_{R,d}⁽ⁱ⁾ represents the power used by the relay node to transmit observation information for the remaining nodes, P_{R,d}⁽ⁱ⁾=α_{R,d}⁽ⁱ⁾[α_{i,d}h_{i,d}²(σ_{θ}²+σᵢ²)+ξ²]; where h_{i,d} is the channel coefficient between the i^{th} node and the fusion center, h_{i,r} is the channel coefficient between the i^{th} node and the node R. As for the relay node, the following stands:

y_{R,d}=\sqrt{α_{R,d}}h_{R,d}x_{R}+n_{R,d},i≢R (2)

The observation model is expressed by a linear observation form y=lθ+ν, wherein l, ν represents an observation vector and a noise vector respectively. The following stands:

l=[l_{1,d}⁽¹⁾,l_{1,d}⁽²⁾, . . . ,l_{R-1,d}⁽¹⁾,l_{R-1,d}⁽²⁾,l_{R,d},l_{R+1,d}⁽¹⁾,l_{R+1,d}⁽²⁾. . . ,l_{K,d}⁽¹⁾,l_{K,d}⁽²⁾]^{H}

l_{i,d}⁽¹⁾=\sqrt{α_{i,d}}h_{i,d},i≢R,

l_{i,d}⁽²⁾=\sqrt{α_{R,d}⁽ⁱ⁾}h_{i,R}\sqrt{α_{i,d}}h_{R,d},i≢R,

l_{R,d}=\sqrt{α_{R,d}}h_{R,d}. (3)
ν can be expressed as follow:

ν=[ν_{l,d}⁽¹⁾,ν_{l,d}⁽²⁾, . . . , ν_{R-1,d}⁽¹⁾,ν_{R-1,d}⁽²⁾,ν_{R,d},ν_{R+1,d}⁽¹⁾,ν_{R+1,d}⁽²⁾, . . . ,ν_{K,d}⁽¹⁾,ν_{K,d}⁽²⁾]^{H}

ν_{i,d}⁽¹⁾=\sqrt{α_{i,d}}h_{i,d}nᵢ+n_{i,d}⁽¹⁾,i≢R,

ν_{i,d}⁽²⁾=\sqrt{α_{R,d}⁽ⁱ⁾}h_{R,d}\sqrt{α_{i,d}}h_{i,R}nᵢ+\sqrt{α_{R,d}⁽ⁱ⁾}h_{R,d}n_{i,R}+n_{i,d}⁽²⁾,i≢R,

ν_{R,d}=\sqrt{α_{R,d}}h_{R,d}n_{R}+n_{R,d}. (4)

Once the fusion center receives the observation signal, it obtains the estimation value for the information source to be observed by using the best linear unbiased estimation method, and the following stands:

\hat{θ}=[l^{H}C⁻¹l]⁻¹l^{H}C⁻¹ (5)

In the above equation, the left side represents the estimation value of the information source. In the present invention, O^{H} represents a conjugate transpose, C is a noise covariance matrix, C=E[w^{H}], wherein the bold represents a vector.

The problem of optimal power distribution can be expressed in the following form:

$${min}_{{α}_{i , d} , {α}_{R , d}^{( j )}} {( {1}^{H} {C}^{- 1} 1 )}^{- 1} i , j = 1 , … , K , j \neq R . \\ s . t . {\sum }_{i = 1}^{K} {α}_{i , d} ( {σ}_{θ}^{2} + {σ}_{i}^{2} ) + {\sum }_{j = 1 , j \neq R}^{K} {α}_{R , d}^{( j )} [ {α}_{j , d} {h}_{j , R}^{2} ( {σ}_{θ}^{2} + {σ}_{j}^{2} ) + {ξ}^{2} ] \leq {P}_{tot} . \\ {α}_{i , d} \geq 0 , {α}_{R , d}^{( j )} \geq 0 , \\ {α}_{i , d} ( {σ}_{θ}^{2} + {σ}_{i}^{2} ) \leq {P}_{ma x} , {α}_{R , d}^{( j )} [ {α}_{j , d} {h}_{j , R}^{2} ( {σ}_{θ}^{2} + {σ}_{j}^{2} ) + {ξ}^{2} ] \leq {P}_{ma x} \qquad ( 6 )$$

The first inequality represents the total power constraint, and the upper limit in this constraint is represented by Pₜₒₜ. The second constraint indicates that the amplification coefficient must make a physical sense. The upper limit of transmission power for each node is defined in the third constraint, and this upper limit is represented by Pₘₐₓ. It proves that this problem is a convex problem, and thus it can be solved by the common solving means of convex optimization.

In the above embodiments of the present invention, said step 5 specifically may comprise:

the non-relay node transmits its observation signal to the fusion center in the first time slot, while the relay node monitors such an observation signal and obtains its noisy copy;

then, in the second time slot, the relay node transmits the obtained noisy copy to the fusion center in an amplify-forward manner.

Said step 6 specifically can comprise: said fusion center carries out information fusion on all of the received observation information by using the best linear unbiased estimation method, so as to obtain the estimation value of said information source.

In a specific embodiment, the equation for calculating the estimation value is:

\tilde{θ}=[l^{H}C⁻¹l]^{H}C⁻¹y.

The estimation accuracy and the outage probability are two important technical indices in the distributed estimation system. The estimation accuracy is obtained by a Monte-Carlo method, and reference can be made to the equation (5) for the method of calculating this estimation accuracy in a one-pass realization. The outage probability refers to the probability that a certain estimation error index is met in the system, and can be expressed by:

P_{D}_{₀}=Prob{Var[\hat{θ}]>D₀} (7)

where D₀ indicates the estimation error index; Var[\hat{θ}] indicates the mean-square value of estimation error for the θ observation value in a one-pass channel realization, and P_{D0} represents the probability that the estimation error index is not met.

By using the cooperative estimation mechanism in the present invention, it is possible to obtain higher estimation accuracy and lower outage probability than the common distributed estimation as well as the node directly transmitting and power distribution optimization mechanism existing in the art.

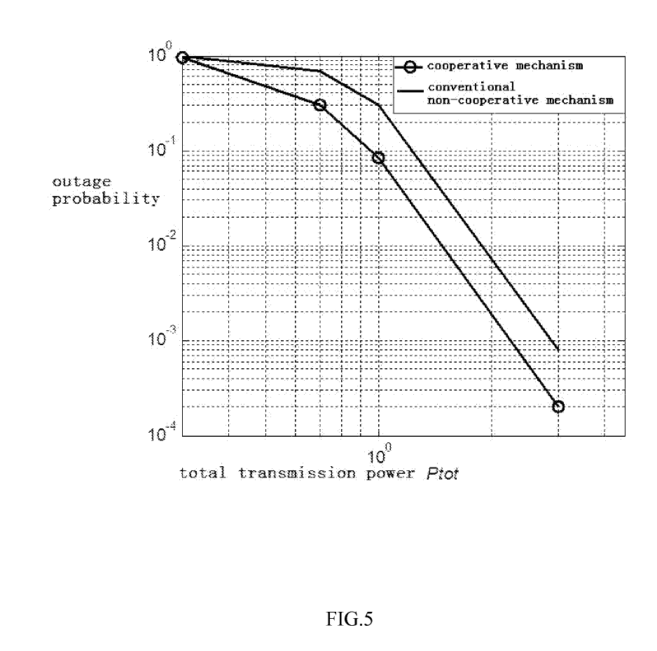

FIG. 4 is a diagram of simulation result test for comparing the estimation accuracy between the present invention and the prior art, which indicates that the mean-square error of the conventional non-cooperative mechanism is much higher than that of the present invention. FIG. 5 is a diagram of simulation result test for comparing the outage probability between the present invention and the prior art, which indicates that the outage probability of the conventional non-cooperative mechanism is much higher than that of the present invention. In figure, Cui optimization mechanism indicates a node directly transmitting and power distribution optimization mechanism, and the common distributed estimation indicates a mechanism in which the node directly transmits without power distribution optimization. From the simulation result test, it can be seen that the present invention enables a lower estimation error and a lower outage probability, in case of the same total transmit power. In other words, the present invention has higher estimation accuracy, thus improving the performance of the estimation system.

It will be understood by the skilled in the art that all or part of the steps for realizing the above method embodiment can be fulfilled by hardware in connection with programs and instructions, and the programs may be stored in a computer readable storage medium. Upon execution, the programs carry out the steps comprising the above method embodiment. The storage medium comprises ROM, RAM, diskette, optical disc, or any medium which can store program codes.

Finally it is noted that the above embodiments only elucidate but not limit the present invention. While the present invention has been described in connection with preferred embodiments, it will be understood that modifications and equivalents thereof within the principles outlined above will be evident to those skilled in the art, and thus the invention is not limited to the preferred embodiments but is intended to encompass such modifications and equivalents.

What is claimed is:

1. A distributed information source estimation method based on cooperative communication, comprising the following steps:
step 1, the fusion center selects a relay node with the best channel quality from a plurality of sensor nodes, according to the current channel quality between each sensor node and the fusion center;
step 2, said fusion center carries out transmission power distribution on each sensor node, according to the observation quality of each sensor node towards an information source and the current channel quality between each sensor node and the fusion center;
step 3, each sensor node judges whether it is a relay node or not, if so, the method proceeds to step 4, and if not, the method proceeds to step 5;
step 4, the sensor node directly transmits the observation information obtained by observing the information source to said fusion center;
step 5, the sensor node transmits the observation information obtained by observing the information source to said fusion center and the relay node monitors the observation information, then the relay node transmits the observation information to said fusion center again;
step 6, said fusion center fuses all of the received observation information to obtain the estimation value of the information source.

2. The distributed information source estimation method based on cooperative communication of claim 1, wherein the method further comprises the following step between said steps 1 and 2:
channel estimation is carried out on transmit channels between each sensor node and the fusion center to obtain the channel quality.

3. The distributed information source estimation method based on cooperative communication of claim 2, wherein in said step 2, the transmission power distribution is performed in the following manner:
said fusion center adopts a numerical solution method for a convex optimization problem to solve an optimization problem which comprises the following conditions: 1) a total transmission power constraint of a system consisting of said fusion center and said plurality of sensor nodes; 2) a transmission power upper constraint for each sensor node; and 3) a transmission power lower constraint for each sensor node, and finally carries out transmission power distribution on all sensor nodes by applying the solving result.

4. The distributed information source estimation method based on cooperative communication of claim 3, wherein said step 5 specifically comprises:
in a first time slot for information transmission of the information source, the sensor node transmits the observation information obtained by observing the information source to said fusion center, while the relay node monitors the observation information;
prior to a second time slot for information transmission of the information source, the relay node retransmits the monitored observation information to said fusion center in an amplify-forward manner.

5. The distributed information source estimation method based on cooperative communication of claim 4, wherein said step 6 specifically comprises:
said fusion center fuses all of the received observation information with a best linear unbiased estimation method to obtain the estimation value of the information source.

6. The distributed information source estimation method based on cooperative communication of claim 1, wherein in said step 5, the relay node monitors a noisy copy of the observation information, and then the relay node retransmits the noisy copy to said fusion center.
